(19) United States
(12) Patent Application Publication
(10) Pub. No.: US 2015/0287059 A1
(43) Pub. Date: Oct. 8, 2015

(54) FORECASTING DEVICE RETURN RATE

(71) Applicant: CELLCO PARTNERSHIP D/B/A VERIZON WIRELESS, Basking Ridge, NJ (US)

(72) Inventors: Ye OUYANG, Basking Ridge, NJ (US); Carol BECHT, Boonton, NJ (US); Gopinath VENKATASUBRAMANIAM, Bridgewater, NJ (US); Benjamin LOWE, Short Hills, NJ (US); Christopher M. SCHMIDT, Branchburg, NJ (US)

(73) Assignee: CELLCO PARTNERSHIP D/B/A VERIZON WIRELESS, Basking Ridge, NJ (US)

(21) Appl. No.: 14/248,191

(22) Filed: Apr. 8, 2014

(51) Int. Cl. G06Q 30/02; G06Q 10/06

(52) U.S. Cl. CPC G06Q 30/0202; G06Q 10/06393

(57) ABSTRACT

Systems and methods for forecasting device return rates are disclosed. Some implementations include identifying correlations between device return cause codes and corresponding device return rates for one or more devices, computing, based on the identified correlations, correlation indexes for each of the device return cause codes, ranking the computed correlation indexes associated with each of the device return cause codes, selecting, a subset of device return cause codes, determining a relationship between the selected subset of the return cause codes and corresponding device return rates, mapping one or more measured key performance indicators (KPIs) of a particular device to return cause codes of the device, and estimating a device return rate for the particular device based on the mapped KPIs and the determined relationship.

### CROSS REFERENCE TO RELATED APPLICATION

This application is related to U.S. patent application Ser. No. ______, having Attorney Docket Number 20131357 (050108-0820), entitled “EVALUATING DEVICE QUALITY,” being filed concurrently herewith, the entire content of which is incorporated herein by reference.

### BACKGROUND

In recent years, mobile device usage has significantly increased. Mobile devices, such as smartphones, are being designed and manufactured at a rapid rate to satisfy customer demand. Companies manufacturing mobile devices, or wireless network providers marketing manufactured mobile devices, may periodically review device return rates and causes of returns after the devices are launched to market. A review of device return rate may help the companies or the wireless network providers to determine success of a mobile device model or make alterations to future mobile device designs. However, such organizations are unable to predict or forecast device return rates and their causes.

As the foregoing illustrates, a new approach for evaluating device return rates and causes may be desirable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

The drawing figures depict one or more implementations in accord with the present teachings, by way of example only, not by way of limitation. In the figures, like reference numerals refer to the same or similar elements.

FIG. 1 is a high-level functional block diagram of an example of a system of networks/devices that provide various communications for mobile stations and support an example of evaluating device quality.

FIG. 2 is an exemplary overall framework that can be used to obtain and store operational parameters related to a mobile device.

FIG. 3 is an exemplary incremental learning in an analytics engine.

FIG. 4 is an exemplary interface to define relations between data attributes in the metadata.

FIG. 5 illustrates data sources that can provide data to an extract-transform-load (ETL) module and the analytics engine.

FIG. 6 illustrates an exemplary framework to forecast device return rate and cause of return.

FIG. 7 illustrates exemplary relations between measured key performance indexes (KPIs) and cause codes.

FIG. 8 illustrates an exemplary correlation index per primary cause code in a descending order.

FIG. 9 illustrates a correlation index per secondary cause code in a descending order.

FIG. 10 illustrates exemplary cause codes that are primary causes of return for a given device type.

FIG. 11 visualizes relations between selected cause codes and device return rates.

FIG. 12 visualizes relations between any two selected cause codes and device return rates in a 3D space.

FIGS. 13 and 14 illustrate validation results in terms of mean error rates for different original equipment manufacturers.

FIG. 15 is a high-level functional block diagram of an exemplary non-touch type mobile station that can be associated with a device quality evaluation service through a network/system like that shown in FIG. 1.

FIG. 16 is a high-level functional block diagram of an exemplary touch screen type mobile station that can be evaluated by the device quality evaluation service through a network/system like that shown in FIG. 1.

FIG. 17 is a simplified functional block diagram of a computer that may be configured as a host or server, for example, to function as the analytics engine in the system of FIG. 1.

FIG. 18 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various implementations disclosed herein relate to forecasting device return rates and causes. The various implementations allow forecasting of a device return rate and identifying the primary root causes of a return. Such forecasting (or prediction) can allow supply chain teams and manufacturing teams to better track the trend of device quality, estimate inventory (e.g., certified like new return (CLNR) inventory), estimate backup/replacement devices, determine how many pre-launched devices to be ordered from a manufacturer, balance CLNR and new devices, and optimize resources. For example, when a device return rate forecast indicates that a large number of devices for a particular device model are to be returned in the near future, a supply chain team can determine how many backup devices are to be ordered from a manufacturer can increase its stock of backup devices. The backup devices may be provided to end-users when they eventually return their devices. The supply chain team can also balance a count of devices in CLNR inventory with respect to new devices when, for example, it is determined that a large number of the returns occur even before the device is unpackaged by an end user for use. In this scenario, the returned devices may be added to the new device inventory. Using one or more algorithms, the disclosed implementations can construct a model to forecast (or trend) device return rate. The disclosed implementations are not limited to mobile devices and can be applied to other domains where return rates may need to be forecasted. For example, the disclosed implementations can be applied to desktop computers, laptops, hardware tools, food products, clothing and any other consumer goods. Thus, the implementations provide a generalized model to resolve issues related to supply chain stocking and returns.

In some implementations, correlations between device return cause codes and corresponding device return rates for one or more devices may be identified. A device return cause code can represent a reason for return of a device to a vendor of the device and a corresponding device return rate is indicative of a number of times the device is returned with the device return cause code. Based on the identified correlations, correlation indexes for each of the device return cause codes can be computed. The computed correlation indexes associated with each of the device return cause codes can be ranked. A subset of device return cause codes are then selected based on the ranking. The subset can include device return cause codes having higher computed correlation indexes relative to other device return cause codes.

A relationship between the selected subset of the return cause codes and corresponding device return rates can be determined using the subset of the device return cause codes as independent variables for the determining of the relationship. One or more measured key performance indicators (KPIs) of a particular device are then mapped to return cause codes of the device. For example, KPIs belonging to particular performance category are mapped to each corresponding cause code of the performance category. A device return rate for the particular device can then be estimated based on the mapped KPIs and the determined relationship. For example, the determined relationship can be an algorithm that may be used to estimate the device return rate based on the mapped KPIs. The disclosed implementations can further provide a report describing the forecasted return rate including causes for return. The report may include cause codes and KPIs considered in forecasting the device return rate together with an indication of the return rate relative to pre-determined (or acceptable) return rates. For example, the report may include an indication of whether the return rate of the device for a particular cause code is above-par, sub-par or on-par relative to pre-determined (or acceptable) return rate levels. The report may be displayed on a user interface of a computing device.

The report may be used to modify aspects related to a supply chain or an inventory of devices. For example, when it is forecasted in the report that the return rate of a device is higher than an acceptable level for a particular return cause code, then a manufacturer of the device may take actions needed to change certain components of the device during manufacturing or improve quality control for the components associated with the return cause code. In another example, when it is forecasted in that report that devices are to be returned for poor browser performance at a rate higher than an acceptable rate of return, the manufacturer may take actions needed to change the browser of the device during software integration or improve browser testing during software integration. In this way, because the rate of return for a device for a cause code can be forecasted in advance of actual returns and before the device is launched to the market, the manufacturer or a wireless network provider can take pre-emptive actions to address issues with the device. In some implementations, the forecasted return rates for different cause codes may be automatically provided to manufacturing and supply chain components to alter their processes and operations without human intervention. In this scenario, the device return rate forecast report may include or may be replaced by instructions to alter operation of the manufacturing and supply chain components.

Reference now is made in detail to the examples illustrated in the accompanying drawings and discussed below.

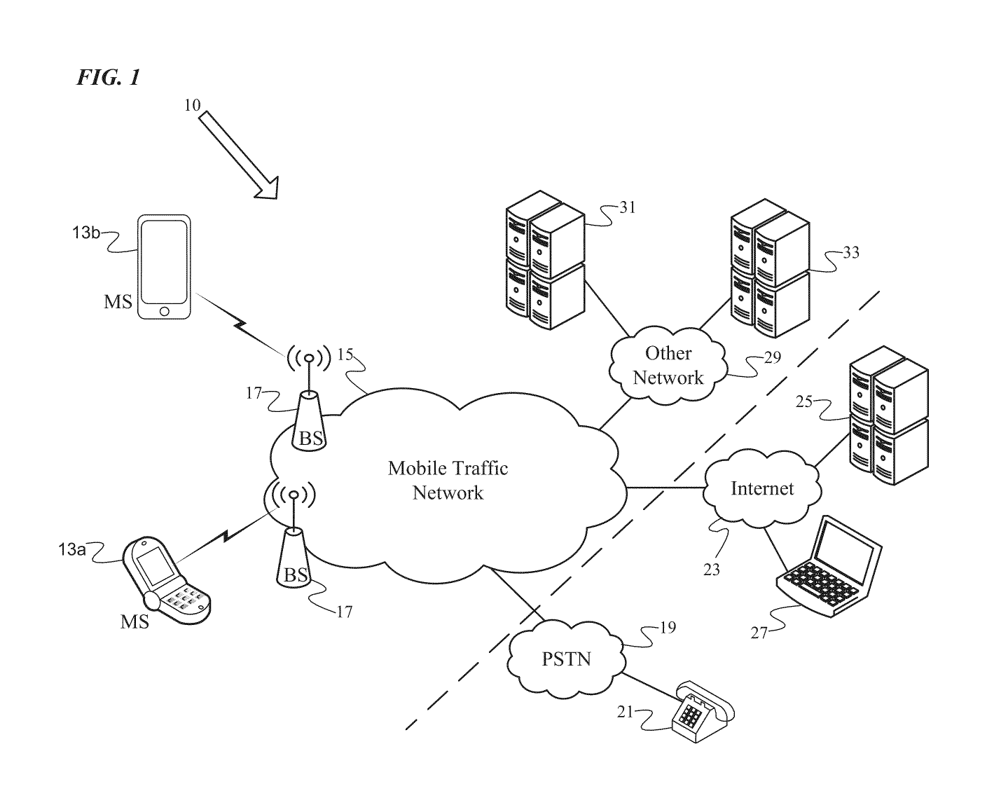

FIG. 1 illustrates a system 10 offering a variety of mobile communication services, including communications associated with forecasting device return rates and causes. The example shows simply two mobile stations (MSs) 13a and 13b as well as a mobile communication network 15. The stations 13a and 13b are examples of mobile stations for which device return rates and causes may be predicted. However, the network will provide similar communications for many other similar users as well as for mobile devices that do not participate in device return rate and cause forecasting. The network 15 provides mobile wireless communications services to those stations as well as to other mobile stations (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless IP network standard including the Global System for Mobile (GSM) communication standard, a Long Term Evolution (LTE) standard or the Evolution Data Optimized (EVDO) standard, a time division multiple access (TDMA) standard or other standards used for public mobile wireless communications. The mobile stations 13 may are capable of voice telephone communications through the network 15, and communications that may be needed to forecasting device return rates and causes, the exemplary devices 13a and 13b are capable of data communications through the particular type of network 15 (and the users thereof typically will have subscribed to data service through the network).

The network 15 allows users of the mobile stations such as 13a and 13b (and other mobile stations not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile stations 13 via the Internet 23 may be with devices like those shown at 25 and 27 as well as with a variety of other types of devices or systems capable of data communications through various interconnected networks. The mobile stations 13a and 13 also can receive and execute applications written in various programming languages, as discussed more later.

Mobile stations 13 can take the form of portable handsets, smart-phones or personal digital assistants, although they may be implemented in other form factors. Program applications, including an application to assist in forecasting device return rates and causes can be configured to execute on many different types of mobile stations 13. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as that serving mobile stations 13, can include one or more RANs and a regional circuit and/or packet switched network and associated signaling network facilities.

Physical elements of a RAN operated by one of the mobile service providers or carriers, include a number of base stations represented in the example by the base stations (BSs) 17. Although not separately shown, such a base station 17 can include a base transceiver system (BTS), which can communicate via an antennae system at the site of base station and over the airlink with one or more of the mobile stations 13, when the mobile stations are within range. Each base station can include a BTS coupled to several antennae mounted on a radio tower within a coverage area often referred to as a “cell.” The BTS is the part of the radio network that sends and receives RF signals to/from the mobile stations 13 that are served by the base station 17.

The radio access networks can also include a traffic network represented generally by the cloud at 15, which carries the user communications and data for the mobile stations 13 between the base stations 17 and other elements with or through which the mobile stations communicate. The network can also include other elements that support functionality other than device-to-device media transfer services such as messaging service messages and voice communications. Specific elements of the network 15 for carrying the voice and data traffic and for controlling various aspects of the calls or sessions through the network 15 are omitted here form simplicity. It will be understood that the various network elements can communicate with each other and other aspects of the mobile communications network 10 and other networks (e.g., the public switched telephone network (PSTN) and the Internet) either directly or indirectly.

The carrier will also operate a number of systems that provide ancillary functions in support of the communications services and/or application services provided through the network 10, and those elements communicate with other nodes or elements of the network 10 via one or more private IP type packet data networks 29 (sometimes referred to as an Intranet), i.e., a private networks. Generally, such systems are part of or connected for communication via the private network 29. A person skilled in the art, however, would recognize that systems outside of the private network could serve the same functions as well. Examples of such systems, in this case operated by the network service provider as part of the overall network 10, which communicate through the intranet type network 29, include one or more application servers 31 and a related authentication server 33 for the application service of server 31.

A mobile station 13 communicates over the air with a base station 17 and through the traffic network 15 for various voice and data communications, e.g. through the Internet 23 with a server 25 and/or with application servers 31. If the mobile service carrier can provide the disclosed device return rate and cause forecasting service, the service may be hosted on a carrier operated application server 31, for communication via the networks 15 and 29. Alternatively, the service may be provided by a separate entity (alone or through agreements with the carrier), in which case, the service may be hosted on an application server such as server 25 connected for communication via the networks 15 and 23. Servers such as 25 and 31 may provide any of a variety of common application or service functions in support of or in addition to an application program running on the mobile station 13. However, for purposes of further discussion, we will focus on functions thereof in support of forecasting device return rates and causes. For a given service, including the device return rate and cause forecasting service, an application program within the mobile station may be considered as a ‘client’ and the programming at 25 or 31 may be considered as the ‘server’ application for the particular service.

To insure that the device return rate and forecasting service offered by the analytics engine 31 is available to only authorized devices/users, the provider of the application service also deploys an authentication server 33. The authentication server 33 could be a separate physical server as shown, or authentication server 33 could be implemented as another program module running on the same hardware platform as the server application 31. Essentially, when the server application (server 31 in our example) receives a service request from a client application on a mobile station 13, the server application provides appropriate information to the authentication server 33 to allow server application 33 to authenticate the mobile station 13 as outlined herein. Upon successful authentication, the server 33 informs the server application 31, which in turn provides access to the service via data communication through the various communication elements (e.g. 29, 15 and 17) of the network 10. A similar authentication function may be provided for any device return rate and forecasting service offered via the server 25, either by the server 33 if there is an appropriate arrangement between the carrier and the operator of server 24, by a program on the server 25 or via a separate authentication server (not shown) connected to the Internet 23.

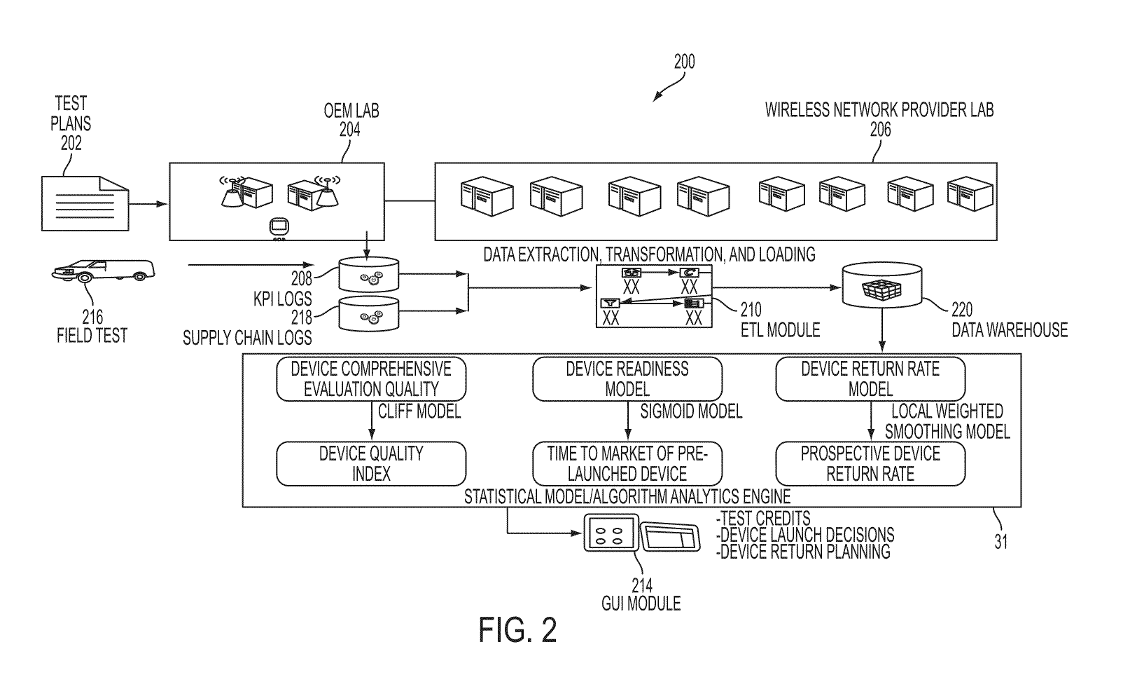

FIG. 2 illustrates an exemplary overall framework 200 that can be used to obtain and store operational parameters related to the mobile station 13a. FIG. 2 illustrates test plans 202, original equipment manufacturer (OEM) lab 204, wireless network provider lab 206, KPI logs 208, Extract-Transform-Load (ETL) module 210, analytics engine 31 and graphical user interface module (GUI) module 214, field tester 216, supply chain logs 218 and data warehouse 220.

In some implementations, the framework of FIG. 2 may be implemented by an organization, such as a wireless network provider. In this example, the wireless network provider may operate the framework 200 to determine the quality of mobile devices that have been manufactured by certain manufacturers for customers of the wireless network provider. In other implementations, the framework 200 may be implemented by any other organization or company to evaluate quality of any device. In other words, the framework 200 is not limited to wireless network providers and mobile devices. Furthermore it is to be appreciated that one or more components illustrated in FIG. 2 may be combined. Operations performed by one or more components may also be distributed across other components.

With reference to FIG. 2 and in some implementations, test plans 202 may include, but are not limited to, data and associated guidelines on how to test the mobile station 13a (or any other device) for quality. The test plans may include machine-readable instructions as well as human-readable instructions. For example, the test plans may be read by a human tester or may be provided to a processor-based computer to perform one or more tests on the mobile station 13a. Such a test may be performed by a processor-based computer to determine certain operational parameters and/or key performance indicators of the mobile station 13a. In some examples, testing of the mobile station 13a may be performed at OEM lab 204. The OEM lab 204 may be a testing facility that is operated by a manufacturer of the mobile station 13a. The OEM lab 204 may be operated by one or more human testers and may include one or more testing stations and testing computers. The wireless network provider lab 206 may be a testing facility similar to the OEM lab 204 but may be operated by a wireless network provider that provides network services for the mobile station 13a. Simply stated, the general purpose of the OEM lab 204 and wireless network provider lab 206 can be to perform one or more tests or measurements on the mobile station 13a to determine operational parameters associated with the mobile station 13a. It is to be appreciated that the implementations are not limited to a single mobile station 13a, but can operate to test and evaluate any number of mobile stations in sequence or in parallel.

In some implementations, KPI logs 208 may include, but are not limited to, data from field tester 216 and OEM lab 204. KPI logs 208 can include KPI data including, but not limited to, mean time between device failure, mean time to device repair, etc. and any other performance parameter. The field tester 216 may test the mobile station 13a in actual situations reflecting a real-world use of the mobile station 13a. KPI logs 208 may also include data from wireless network provider lab 206. As discussed above, data from OEM lab 204 and the wireless network provider lab 206 can include, but are not limited to, operational parameters associated with the mobile station 13a. In some implementations, the data from the KPI logs 208 and the supply chain logs 218 can be retrieved or extracted by the ETL module 210. The ETL module 210 may extract, transform and load transformed data into data warehouse 220. Data transformations may include, but are not limited to, re-formatting of the data into a common or open data format.

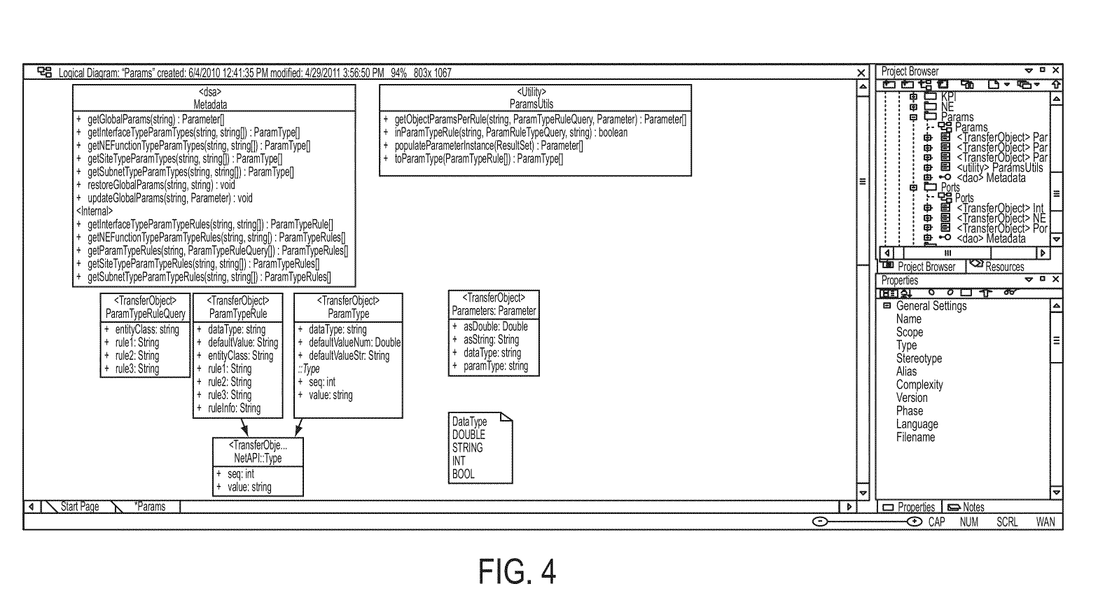

In some implementations, ETL module 210 may receive data as data files in a particular data format (e.g., .drm file format). The ETL module 210 may use a schema to extract data attributes from a .drm file, then format the data, transform the data, and finally load or store the data to the data warehouse 220. The data warehouse 220 may also include metadata associated with the data received from the ETL module 210. Metadata can specify properties of data. In this way, the data warehouse 220 may include, but is not limited to, transformed data field tester 216, the OEM lab 204 and the wireless network provider lab 206. The data from the data warehouse 220 may be read by the analytics engine 31 to evaluate quality of the mobile station 13a using the exemplary methods discussed below. In some implementations, data from the data warehouse 220 may be provided by the data warehouse 220 to the analytics engine 31. The metadata in the data warehouse 220 can define data attributes as well as their relations. The metadata may include two types of metadata; performance data attribute and a configuration data attribute. Performance data attributes may include, but are not limited to, device KPI name, device KPI unit, device KPI threshold (max and limit value), wireless network (RF) KPI name, RF KPI unit, RF KPI threshold (max and limit value) etc. Configuration data attributes may include, but are not limited to, device name, OEM name, device type, hardware configuration parameters, software parameters, sales data, returns data (per cause code), etc. Once data attributes are defined in a metadata file, their relations can be defined. FIG. 4 illustrates an exemplary interface to define the relations between data attributes in the metadata. The interface can be an easy to use web-based interface allows the configuration of mappings between both standard and proprietary data formats, as well as customizing the conversion of data types. In addition, a visualization of derived mappings between source and target formats can also be provided.

In some implementations, the analytics engine 31 includes one or more processors, storage and memory to process one or more algorithms and statistical models to evaluate quality of the mobile station 13a. In some implementations, the analytics engine 31 may train and mine the data from ETL module 210. As an example, a training set can be a set of data used to discover potentially predictive relationships. Training sets are used in artificial intelligence, machine learning, genetic programming, intelligent systems, and statistics. A training set can be implemented to build an analytical model, while a test (or validation) set may be used to validate the analytical model that has been built. Data points in the training set may be excluded from the test (validation) set. Usually a dataset is divided into a training set, a validation set (and/or a ‘test set’) in several iterations (e.g., five to ten fold iterations) when creating an analytical model. In this way, for example, the analytics engine 31 may determine models to evaluate device quality. In some implementations, open interfaces (e.g., application programming interfaces (APIs)) may be provided to vendors for reading/writing data between the ETL module 210 and the analytics engine 31 and for visualizing analytics results between the analytics engine 31 and GUI 214. In some implementations, the wireless network provider may provide access to the analytics engine 31 to a third-party vendor.

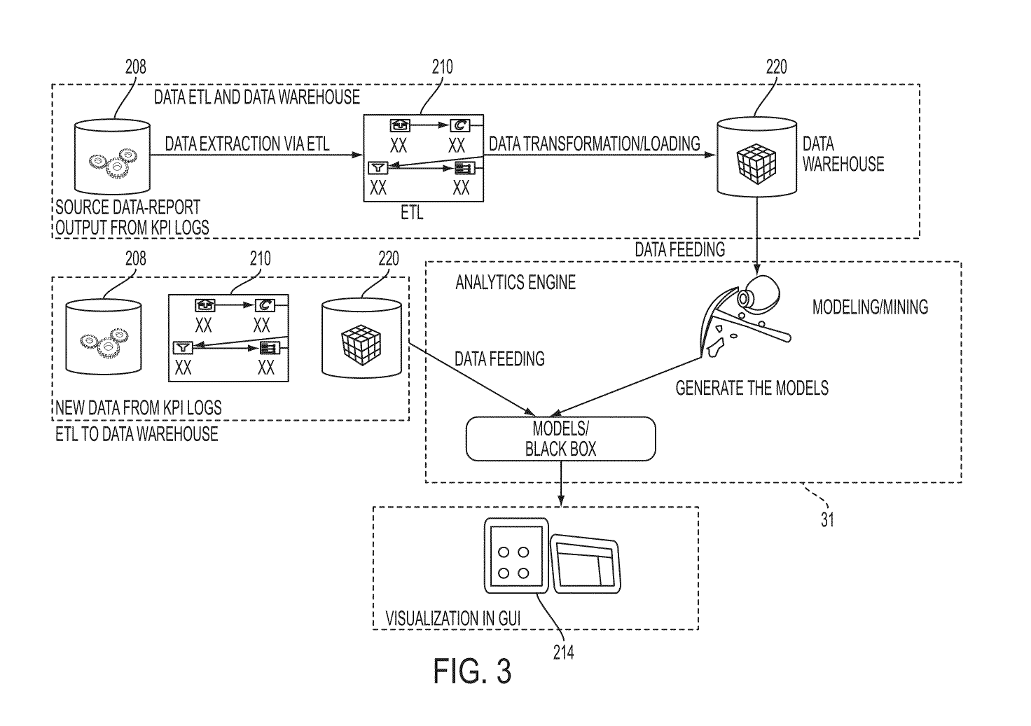

In some implementations, data may be processed incrementally by the analytics engine 31 for instantaneous learning. Incremental learning is a machine learning paradigm where a learning process takes place whenever new example(s) emerge and adjusts what has been learned according to the new example(s). Incremental learning differs from traditional machine learning in that incremental learning may not assume the availability of a sufficient training set before the learning process, but the training examples appear over time. Based on this paradigm, the algorithms utilized by the analytics engine may be automatically updated by re-training the data processed by the analytics engine 31. In some implementations, a dynamic sliding window method may be used to provide data from the ETL module 210 to the analytics engine 31 for algorithm training by the analytics engine 31. The dynamic sliding window may be used by the ETL module 210 to incrementally provide, for example, operational parameters from the mobile station 13a to the analytics engine 31. For example, and with reference to FIG. 3, the analytics engine 31 may receive data incrementally from ETL module 210 and data warehouse 220 as well as data from an KPI tool or KPI logs 208. The analytics engine 31 can incrementally auto-learn and update algorithms (and related formulae) for mathematical models so that the models conform to latest data received from the ETL module 210.

One or more outputs of the analytics engine 31 may be provided to the GUI 214 for display. As an example, the GUI 214 may rendered on a mobile device (e.g., tablet computer, smartphone, etc.) that may display data provided by the analytics engine 31. In some implementations, the GUI 214 can be used to visualize analytical results from analytics engine 31. As an example, results from the analytics engine 31 may be visualized as terms of charts, animations, tables and any other form of graphical rendering.

The analytics engine 31 can further provide a report describing the forecasted device return rate. The report may include cause codes and KPIs considered in forecasting the device return rate together with an indication of the return rate relative to pre-determined (or acceptable) return rates. For example, the report may include an indication of whether the return rate of the device is above-par, sub-par or on-par relative to pre-determined (or acceptable) return rate levels. The report may be displayed on a user interface of a computing device. The report may be used to modify aspects related to a supply chain or an inventory of devices such as the mobile station 13a. For example, when it is forecasted that the return rate of the mobile station 13a is higher than an acceptable level for a particular return cause code then manufacturer of the mobile station 13a may take actions needed to change certain components of the mobile station 13a during manufacturing or improve quality control for the components associated with the cause code. In another example, when it is determined that devices are forecasted to be returned for poor browser performance at a rate higher than an acceptable rate of return, the manufacturer may take actions needed to change certain the browser of the mobile station 13a during software integration or improve browser testing during software integration. In this way, because the rate of return for a device for a cause code can be forecasted in advance of actual returns and before the device is launched to market, the manufacturer or a wireless network provider can take pre-emptive actions to address issues with the device.

In some implementations, the forecasted return rates for different cause codes may be automatically provided by the analytics engine 31 to manufacturing and supply chain components to alter their processes and operations without human intervention. In this scenario, the device return rate forecast report may include or may be replaced by instructions to alter operation of the manufacturing and supply chain components. For example, when a higher than acceptable return rate is forecasted by the analytics engine 31 due to poor network performance, a device that programs firmware for network components on the mobile station 13a may be instructed by the analytics engine 31 to update firmware settings to improve sub-par network performance for the mobile station 13a. Also, for example, when a higher than acceptable return rate is forecasted due for a particular cause, a robotic arm integrating or soldering components on the mobile station 13a may be instructed by the analytics engine 31 to increase speed or rate of operation to have a larger number of replacement devices ready to service the forecasted higher return rate.

In implementations, where the return rates are forecasted for devices post-launch, the device return rate forecast report may be automatically transmitted by the analytics engine 31 to one or more computers operated at stores that sell the mobile station 13a to end users. The device return rate forecast report may be used by store employees to increase/decrease stock of backup device inventory to service anticipated returns. The store employees may also use the reports to issue device recall requests to end users so that known issues with devices may be resolved before they are reported by the end-users. Also for example, if device return rate forecast report indicates that when it is determined that devices are forecasted to be returned for poor browser performance at a rate higher than an acceptable rate of return, the store employees may better prepare themselves to service anticipated browser issues. In some implementations, a new device quality evaluation report may be transmitted by the analytics engine 31 to the one or more computers at pre-determined intervals (e.g., hourly, daily, weekly, monthly, etc.).

In some implementations, GUI 214 may display a data model, algorithm(s), and inter-component communications. The GUI 214 may include a dashboard based to support multiple applications while providing a unified look and feel across all applications. The GUI 214 may display reports in different formats (e.g., .PDF, .XLS, etc.). The GUI 214 may allow open APIs and objects for creation of custom report(s) by users. The GUI 214 may keep the internal schema for the data warehouse 220 hidden from users and provide GUI features that include, but are not limited to, icons, grouping, icon extensions and administration menu(s). Overall, the GUI 124 can provide a consistent visual look and feel and user friendly navigation.

In some implementations, the analytics engine 31 can be implemented as a device analytics tool. Such a device analytics tool can be, for example, an extension of a Diagnostic Monitoring Tool to further evaluate device quality for any pre-launched devices. On-board diagnostics can refer to a device's self-diagnostic and reporting capability. Diagnostic monitoring tools can give a device tester or repair technician access to status of various device sub-systems. Diagnostic monitoring tools can use a standardized digital communications port to provide real-time data.

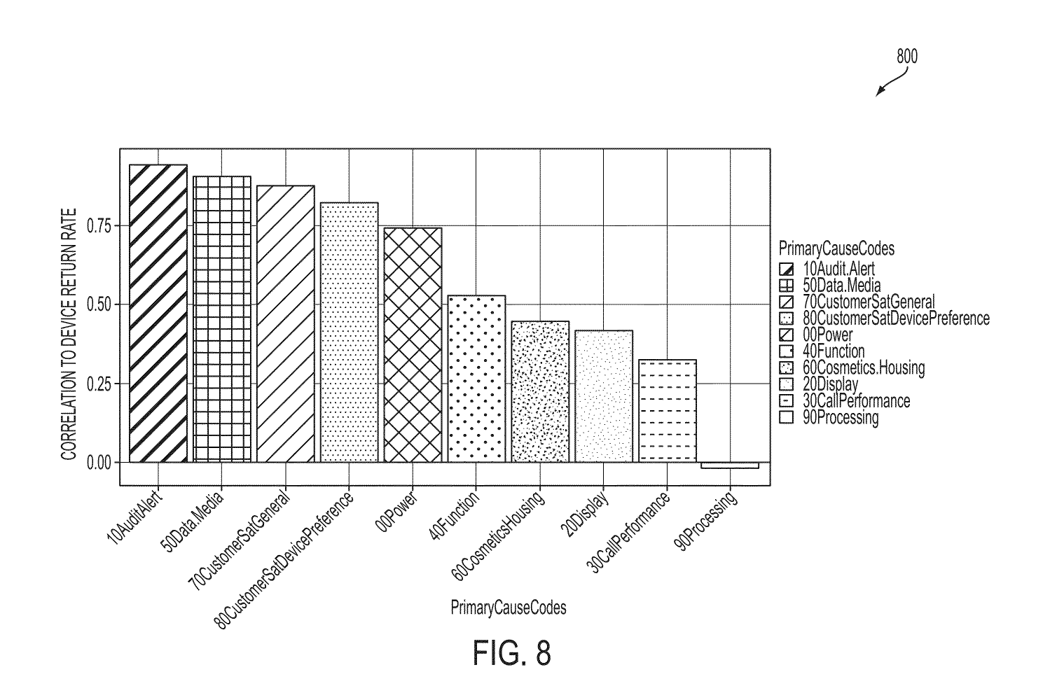

The analytics engine 31 can be a tool to apply statistical modeling algorithms to study device quality, evaluate device readiness, and forecast device return rate etc. More statistical models can be embedded/stored in the analytics engine 31 based on business needs. The analytics engine 31 can allow a device quality team to investigate device quality from several aspects, including, but not limited to, device quality, device readiness and device return rate. For example, when evaluating device quality, a cliff model can be developed by the analytics engine 31 to comprehensively evaluate device quality in terms of a device quality index which reflects user's experience with device quality in high dimensional spaces. An exemplary, device quality evaluation using a cliff model is discussed further below with respect to FIG. 8.

When evaluating device readiness, a sigmoid model can be developed by the analytics engine 31 to forecast the time to market for a given pre-launched device. When evaluating device return rate, a Local Weighted Scatter-Plot Smoothing (LOESS) model can developed by the analytics engine 31 to forecast potential device return rate for a given pre-launched device. This model can also be leveraged by the analytics engine 31 to forecast device return rate for a post-launched device. In some implementations, the analytics engine 31 supports the functionality of instantaneous data extraction from a KPI module (e.g., KPI logs 208) as well as instantaneous data transformation and loading. Instantaneous data processing in ETL module 210 can refer to access to KPI data library (e.g., KPI logs 208) for data extraction. Data obtained from the KPI logs 208 may be a quasi-instant step. The ETL module 210 can detect new data that is uploaded to KPI logs 208. The ETL module 210 can perform operations immediately once the new data file is detected in KPI logs 208. Appropriate outlier exclusion approaches may be implemented in the ETL module 210 to exclude and convert outliers, or data that may not conform to known formats, in raw data files. In some implementations, a wireless network provider may provide the outlier detection algorithms to a vendor that provides KPI tools to collect data into KPI logs 208.

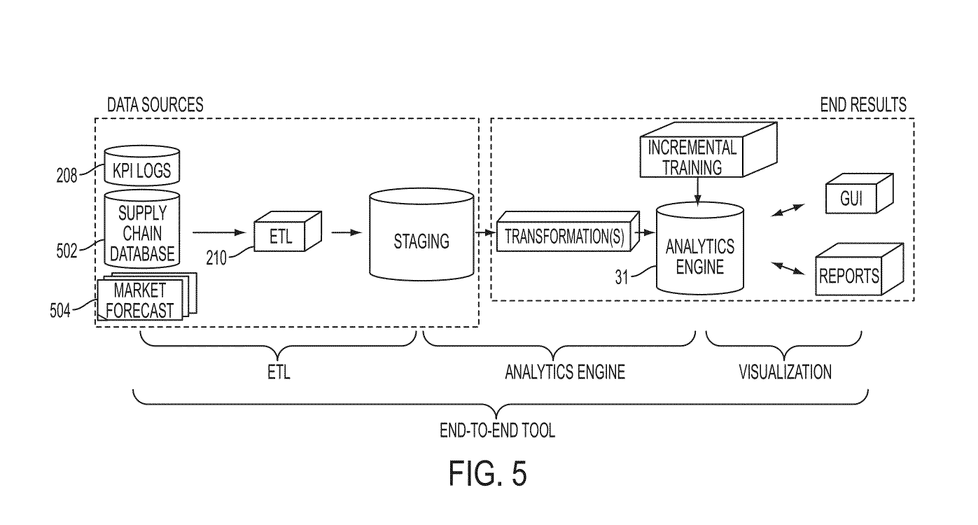

FIG. 5 illustrates different data sources of the analytics engine 31. In some implementations, there can be three primary data sources to ETL module 210 and the analytics engine 31. These data sources include KPI logs 208, supply chain database 502, and market forecast data 504.

In some implementations, the KPI logs 208 may be a primary data source to obtain performance data. There can be two data formats available in the KPI logs 208 for the analytics engine 31. One format can be a .DRM format, which can be used to store an original log file uploaded by KPI tool users to a KPIdata library. The other format can be a .CSV file, which can be used to store a report generated by a KPI tool. It can be viewed as a “processed log” via a KPI tool.

Supply chain database 502 can store data related to device rate of return. In some implementations, the wireless network provider can provide device returns data extracted from a logistics dashboard associated with the supply chain database 502 in a .CSV file. Queries and scripts may be run by ETL module 210 to extract raw data from the supply chain database 502 and save the data as .CSV files. ETL module 210 may accept and feed the data to the analytics engine 31 for further processing.

In implementations, market forecast data 504 can provide the sales data per device per month. This dataset can be merged with the device returns data from the supply chain database 502. The merged data may be used by the analytics engine 31 as a heuristic to forecast the return rate for pre-launched devices. Granularity of load-performance data can be seconds, minutes, or busy hour intervals. Returns data and sales data may have granularity of weeks or months.

In some implementations, after data is processed by the ETL module 210 but before it is passed to staging, a step of outlier exclusion may be implemented by the ETL module 210. In some implementations, an inter-quartile range (IQR) algorithm may be implemented in the ETL module 210 to exclude outliers. In descriptive statistics, the interquartile range, also called the midspread or middle fifty, is a measure of statistical dispersion, being equal to the difference between the upper and lower quartiles.

In some implementations, the ETL module 210 can define a unified target file. Each data attribute in metadata can be mapped by the ETL module 210 to a given column in the target file. The target file is generated as the output file by the ETL module 210 and then provided by the ETL module 210 to the analytics engine 31 for further data mining and data processing. This target file can be utilized by the analytics engine for statistical analysis (e.g., statistical analysis of the mobile station 13a). In some implementations, the ETL module 210 may need to split the target file into several files such as a performance file, a configuration file, etc.

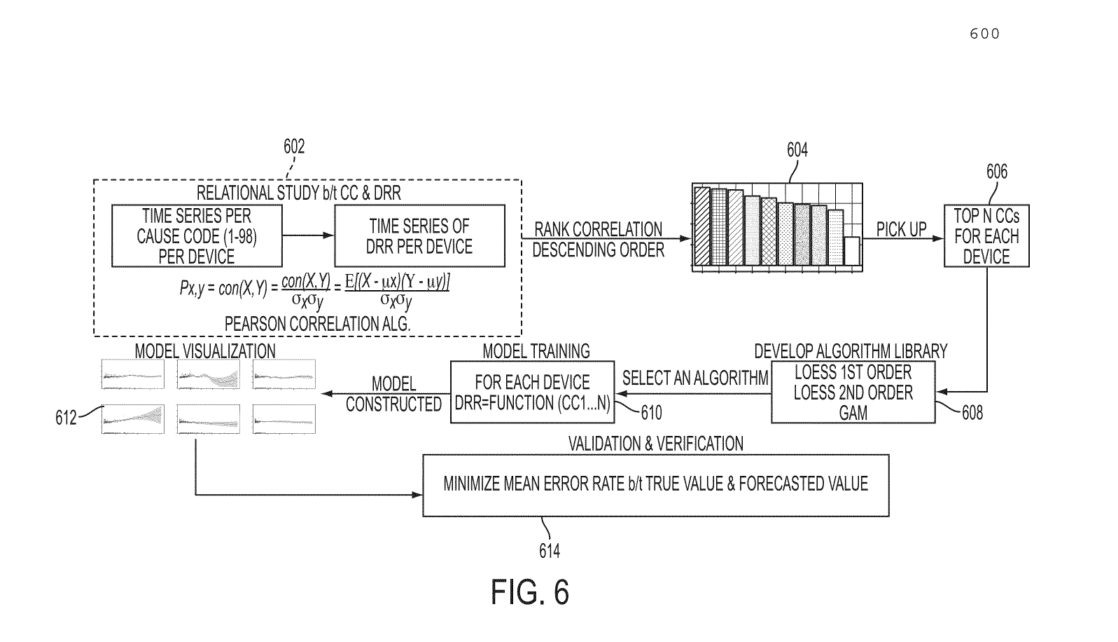

FIG. 6 illustrates an exemplary framework 600 to forecast device return rate and cause of return. In some implementations, the framework 600 may be implemented in the analytics engine 31. In some implementations, correlation module 602 can identify correlations between device return cause codes and corresponding device return rates for one or more devices. As noted earlier, a device return cause code can represent a reason for return of a device to a vendor of the device and a corresponding device return rate is indicative of a number of times the device is returned with the device return cause code. Devices may be returned by users to a brick and mortar store of the vendor or even shipped back to the vendor. When returning the device, the user may provide one or more causes of return to the customer service representative. Causes of return can include, but are not limited to, poor network connectivity, inability in charging a device, poor battery performance, overheating, cracked screen, display resolution issues, etc. In this way, the causes of returns may be recorded in a database by the vendor and shared or transmitted to the analytics engine.

In some implementations, correlation module 602 can identify the correlation between a time series per cause code and a time series per device return rate. The time series per cause code or per device return is a temporal indication of the return rate with respect to a plurality of cause codes. For example, the time series may have a monthly or a daily basis. Such a temporal indication may be visualized as graph. An example of such a graph is discussed further below with respect to FIG. 8. The correlation module 602 can detect which return cause code shows a highest correlation to device return rate. For example, a “Device Screen Fails” return cause code may be associated with a largest number of returns for a particular device. A return cause code showing high correlation is a good candidate to regress or forecast device return rate. In some implementations, regression analysis may be used to forecast the device return rate. Regression analysis includes a group of methods for predicting future values of a variable using information about other variables. It includes techniques for modeling and analyzing several variables when the focus is on the relationship between a dependent variable and one or more independent variables. More specifically, regression analysis helps one understand how the typical value of the dependent variable (or changes when any one of the independent variables is varied, while the other independent variables are held fixed. As will be discussed further below, the disclosed embodiments may select a particular set of cause codes as independent variables to perform regression analysis. Variables other than the selected set of cause codes may be used as dependent variables. In this way, a statistical relation study between cause codes and device return rate may be performed by the correlation module 602.

In some implementations, based on the identified correlations, correlation indexes for each of the device return cause codes can be computed by the module 602. The computed correlation indexes associated with each of the device return cause codes can be ranked by ranking module 604. A subset of device return cause codes is then selected based on the ranking by the selector module 606. The subset can include device return cause codes having higher computed correlation indexes relative to other device return cause codes. In this way, after obtaining the correlation index per cause code, they may be ranked in a descending order. Then, the top “N” cause codes can be selected by the selector module 606 as independent variable candidates in equations used by the relationship and algorithm computer 608 to forecast device return rate.

In an alternative implementation, high correlations between a time series per cause code and a time series per device return rate may not be presumed by the analytics engine 31 to provide independent variables to forecast device return rate. In other words, independent variables to forecast device return rate can be determined by the analytics engine 31 independent of correlations between a time series per cause code and a time series per device return rate. As noted above, independent variables may be used as independent variables by relationship and algorithm computer 608 to forecast a device return rate. In this scenario, selector module 606 may traverse all known return cause code correlations to regress the device return rate. In some implementations, selector module 606 may traverse millions of correlations (e.g., from correlation 1 to N). Then, selector module 606 may select a particular number of correlations (e.g., 6 out of 98). The particular number of correlations may be pre-defined by the analytics engine 31 is a particular value N or may be randomly selected within a particular range of values. Further, based on input from the selector module 606, the relationship and algorithm computer 608 can select a model for forecasting a device return rate that is associated with a correlation having a least mean error rate.

A relationship between the selected subset of the return cause codes and corresponding device return rates can be determined by relationship and algorithm computer 608 using the subset of the device return cause codes as independent variables for the determining of the relationship. In some implementations, a Local Weighted Scatter-plot Smoothing (LOESS) algorithm can be used by the algorithm computer 608 to construct a non-linear relation between the selected cause codes and device return rate. The derived relation can then be used by the model training and forecasting module 610 to forecast a device return rate.

One or more measured KPIs of a particular device are then mapped by the relationship and algorithm computer 608 to return cause codes of the device. For example, KPIs belonging to particular performance category are mapped to each corresponding cause code of the performance category. A device return rate for the particular device can then be estimated (or forecasted) by the model training and forecasting module 610 based on the mapped KPIs, the relationship between the selected subset of the return cause codes and the corresponding device return rates previously determined by the algorithm computer 608.

Visualization module 612 may generate a model visualization indicative a mapping between the measured key performance indicators (KPIs) and return cause codes of the device. Visualization module 612 can help visualize the pair-wise relation between any selected cause code and device return rate. Validation and verification module 614 can validate a difference between an estimated device return rate and a true (or measured) value of a device return rate. A least mean error rate is expected from the model determined by relationship and algorithm computer 608.

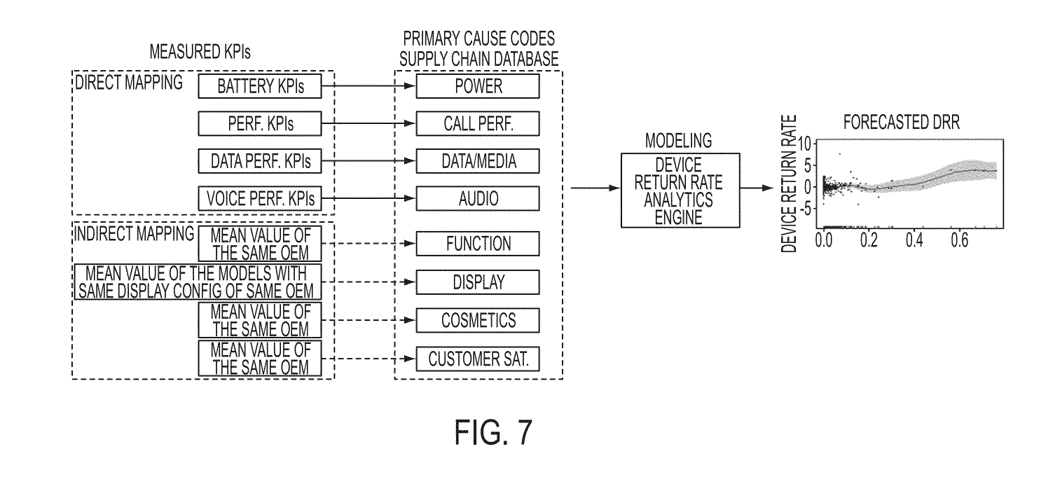

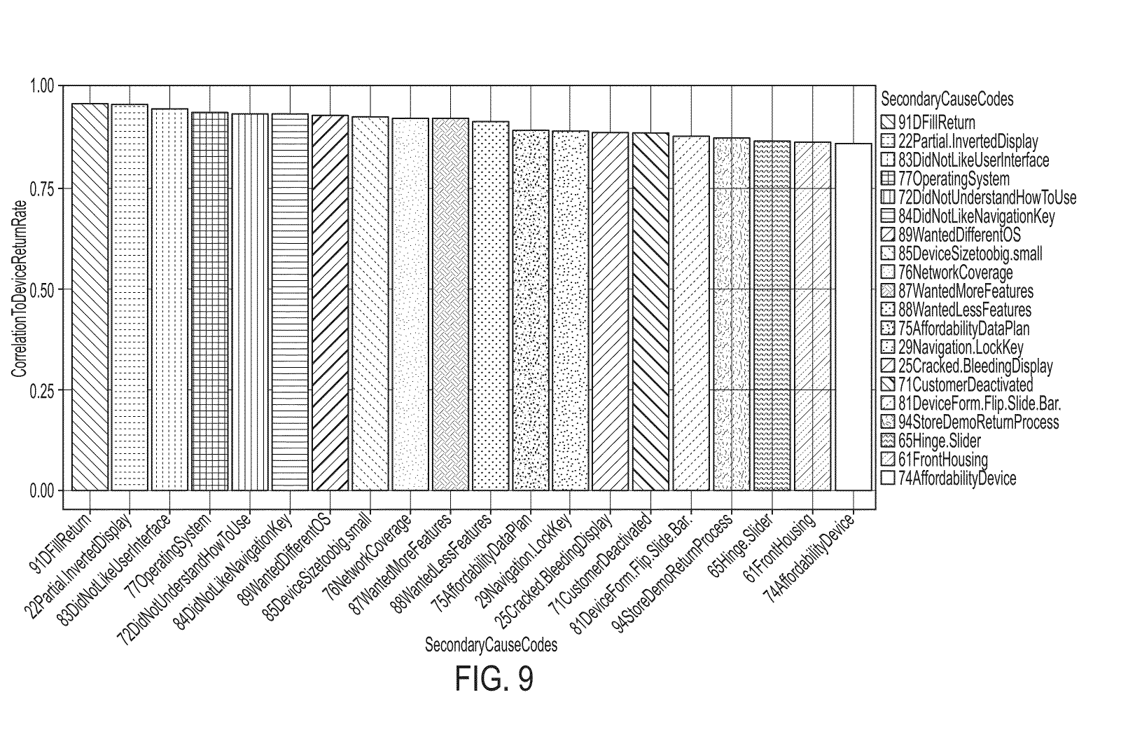

FIG. 7 illustrates a “map-able” relation between measured KPI and cause codes. To forecast the potential return rate for a given pre-launched device, correlation module 620 can map the measured KPIs to cause codes due to the unavailability of cause codes data for a pre-launched device. KPIs belonging to certain category are mapped to each corresponding cause code. Then, training and forecasting module 610 leverages the formula derived from relationship and algorithm computer 608 above to derive the relation between measured KPIs and potential device return rate. FIG. 8 displays the correlation index per primary cause code in a descending order. Such a relational graph (or another representation) can be an output from selector module 606, which prepares independent variable candidates to regress (or forecast/estimate) device return rate. Graph 800 illustrates primary cause codes on the horizontal axis and correlation to device return rates on the vertical axis. Similar to FIG. 8, FIG. 9 displays the correlation index per secondary cause code in a descending order. Such a correlation index can be output from selector module 606, which prepares the independent variable candidates to regress device return rate.

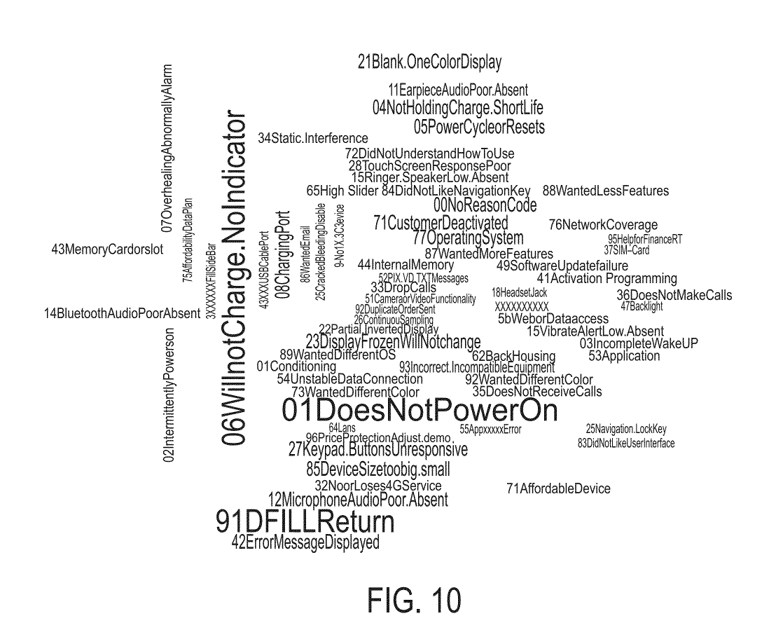

FIG. 10 illustrates which cause codes are the primary causes of return for a given device type. Such a word cloud may be generated and displayed by the visualization module 612 in addition to the forecasted return rate report discussed above. A word cloud is a visual representation for text data. The frequency of occurrence return cause codes may be used to determine the size of the text associated with the cause code. In other words, when visualized text size of a particular cause code is greater with respect to other cause codes, this indicates that the particular cause code more frequently is a reason for a device's return relative to other cause codes. Word clouds are useful for quickly perceiving the most prominent terms. Such visualization can help a wireless network provider team quickly identify the primary causes of return for a given device (e.g., the mobile station 13a).

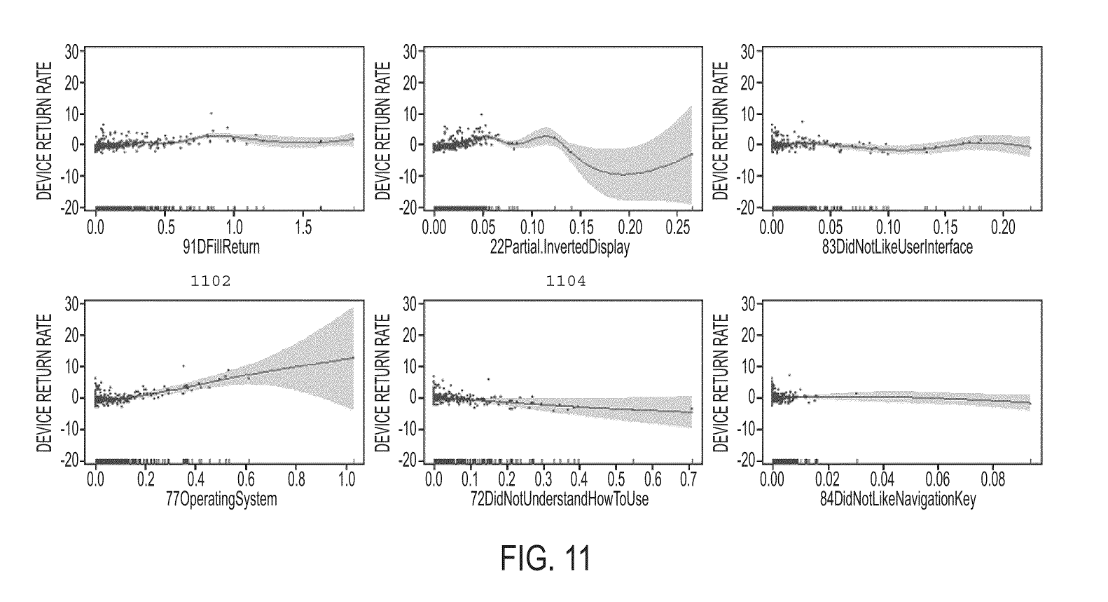

FIG. 11 visualizes relations between any selected cause code and device return rate. FIG. 11 shows that the selected cause codes jointly regress device return rate in a multi-dimensional space. For example, the different return codes illustrated on the horizontal axis in FIG. 11 include “Partial Inverted Display,” “Did Not Like User Interface,” “Operating System,” “Did No Understand How To Use,” “Did Not Like Navigation Key,” etc.

The curves illustrated in FIG. 11 can be computed by the analytics engine 31 using a set of data points corresponding to device return rates. The visualizations of FIG. 11 can be considered to be scatter-grams. In a scatter-gram, when a parameter exists that is systematically incremented and/or decremented by the other, the parameter is called the control parameter or independent variable and is customarily plotted along the horizontal axis. The measured or dependent variable is customarily plotted along the vertical axis. If no dependent variable exists, either type of variable can be plotted on either axis and a scatter-gram can illustrate a degree of correlation between two variables. As an illustrative example, each smoothed curve value can be computed by the analytics engine 31 using a weighted quadratic least squares regression over the span of values of the y-axis scatter-gram independent variable.

A scatter-gram may suggest various kinds of correlations between variables with a certain confidence interval. Correlations may be positive (rising), negative (falling), or null (uncorrelated). As an illustrative example, if the pattern of data points or dots slopes from lower left to upper right, this can suggest a positive correlation between the variables being studied. If the pattern of dots slopes from upper left to lower right, it may suggest a negative correlation. A line of best fit (alternatively called ‘trendline’) can be drawn in order to study the correlation between the variables. An equation for the correlation between the variables can be determined by established best-fit procedures. For a linear correlation, the best-fit procedure is known as linear regression and is guaranteed to generate a correct solution in a finite time. A scatter-gram is also useful when it is to be seen how two comparable data sets agree with each other. In this case, an identity line, i.e., a y=x line, or a 1:1 line, is often drawn as a reference. The more the two data sets agree, the more the scatters tend to concentrate in the vicinity of the identity line; if the two data sets are numerically identical, the scatters fall on the identity line exactly. One of the most powerful aspects of a scatter-gram, however, is its ability to show nonlinear relationships between variables. Furthermore, if the data are represented by a mixture model of simple relationships, these relationships will be visually evident as superimposed patterns.

In some cases, the curves may be determined by the analytics engine 31 using locally weighted polynomial regression. In this method, at each point in the data set a low-degree polynomial is fitted to a subset of the data, with explanatory variable values near the point whose response is being estimated. The polynomial can be fitted using weighted least squares, giving more weight to points near the point whose response is being estimated and less weight to points further away. The value of the regression function for the point is then obtained by evaluating the local polynomial using the explanatory variable values for that data point. The method is complete after regression function values have been computed for each of the N data points representing device return rates.

For example, visualization 1102 illustrates a relationship between a cause code related operating system issues and the corresponding device return rate. Visualization 1102 includes different data points corresponding to error rates related to operating system issues. Visualization 1102 may indicate that the device return rate is forecasted to increase from an initial factor that is close to zero up to a value of ten. This may indicate that there is increasing likelihood that a device is to be returned for operating system issues. When it is forecasted that devices are to be returned for operating system issues at a rate higher than an acceptable rate of return, the manufacturer may take actions needed to change an operating system version of the mobile station 13a during software integration or improve operating system testing during software integration. In this way, because the rate of return for a device for a cause code can be forecasted in advance of actual returns and before the device is launched to market, the manufacturer or a wireless network provider can take pre-emptive actions to address issues with the device. In some implementations, the forecasted return rates for cause codes may be automatically provided to manufacturing and supply chain components to alter their processes and operations without human intervention. In this scenario, the device return rate forecast report may include or may be replaced by instructions to alter operation of the manufacturing and supply chain components. This example is purely illustrative and is not intended to limit the disclosed implementations.

For example, visualization 1104 illustrates a relationship between a cause code related to a user's inability in understanding use of a device and the corresponding device return rate. Visualization 1104 includes different data points corresponding to error rates related to operating system issues. Visualization 1104 may indicate that the device return rate is forecasted to decrease from an initial factor that is close to ten to eventually zero. This may indicate that there is a decreasing likelihood that a device is to be returned for the user's inability in understanding use of the device. When it is determined that devices are forecasted to be returned for this particular issue at a lower than an acceptable rate of return, the manufacturer may not take actions needed to change a user interface design of the mobile station 13a during software integration or alter user interface testing during software integration. Other visualizations illustrated in FIG. 11 represent similar relationships for other cause codes and corresponding return rates.

In this way, because the rate of return for a device for a cause code can be forecasted in advance of actual returns and before the device is launched to market, the manufacturer or a wireless network provider can take pre-emptive actions to address issues with the device. This example is purely illustrative and is not intended to limit the disclosed implementations.

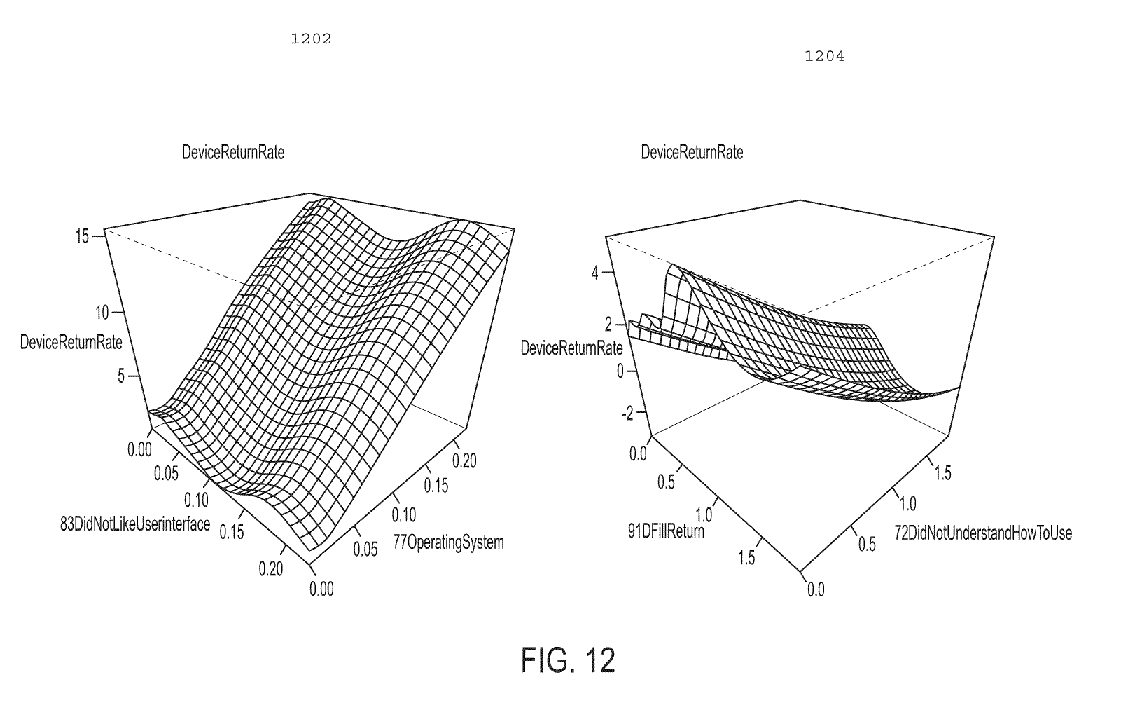

FIG. 12 visualizes relations between any two selected cause codes and device return rates in a multi-dimensional space.

The surfaces illustrated in the FIG. 12 can be computed by the analytics engine 31 from a combination of any two visualizations illustrated in FIG. 11. The surfaces may be computed using multiple scalar variables and associated the variables for different axes in phase space. The different variables may be combined to form coordinates in the phase space and displayed as surfaces.

For example, visualization 1202 illustrates multi-dimensional relations between return rates corresponding to user interface issues and those corresponding to operating system issues. Visualization 1204 illustrates multi-dimensional relations between return rates corresponding to user interface issues and those corresponding to operating system issues. Visualization module generated multi-dimensional visualizations like 1202 and 1204 are useful because they enable quality control personnel at an OEM or a wireless network provider to view relationships between multiple causes of return in a single visualization.

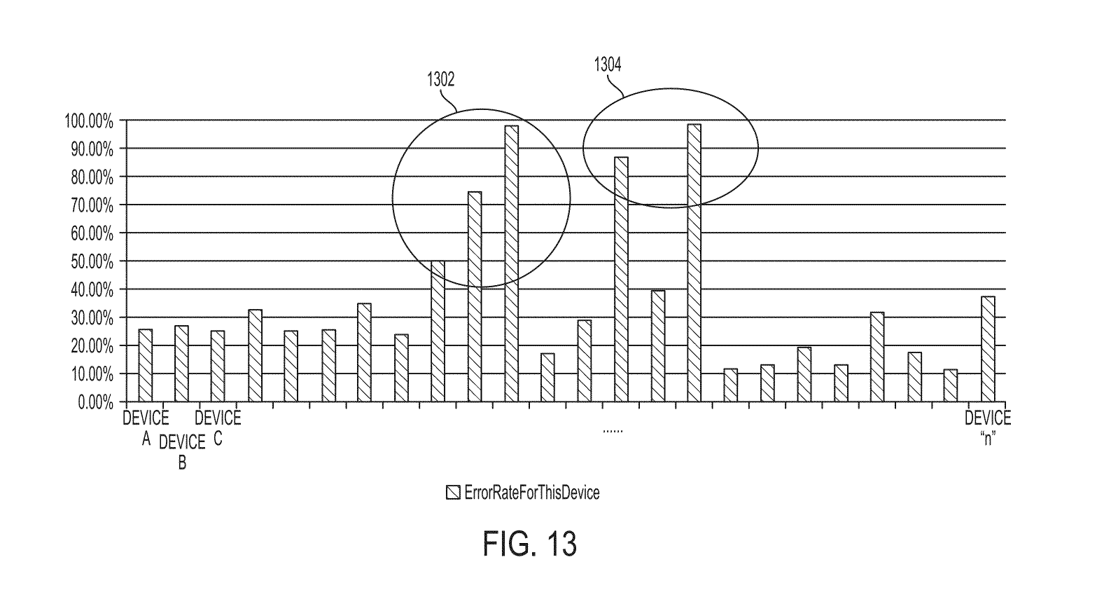

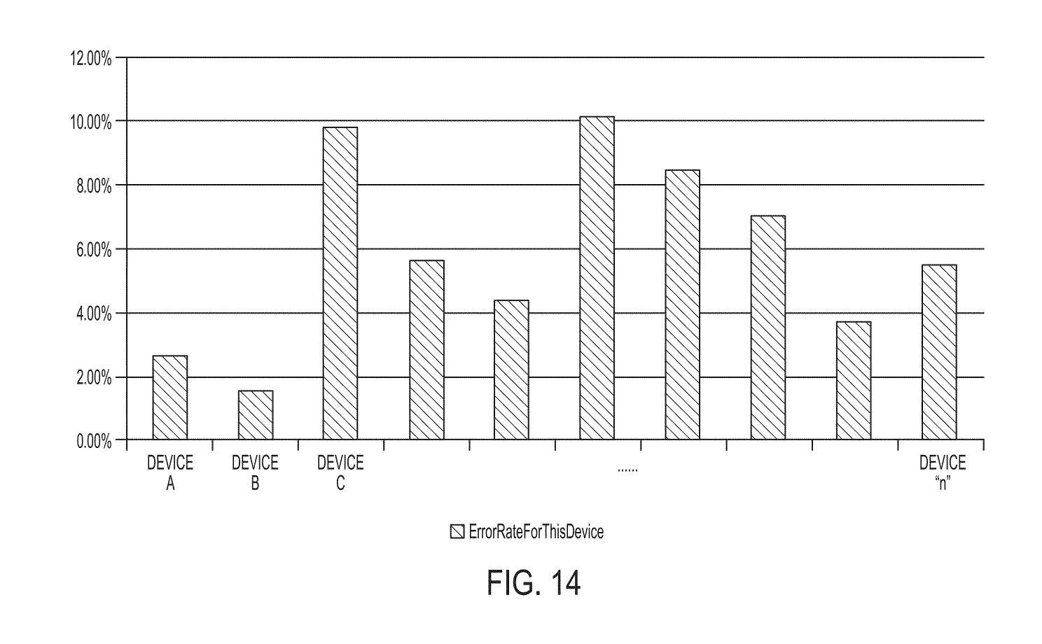

FIGS. 13 and 14 display the validation results in terms of mean error rate. FIG. 13 illustrates validation results for OEM A. The mean error/defect rate for all OEM A devices are below 25% on average. This can indicate that the mean accuracy rate is above 100−25%=75%, which may be acceptable to a wireless network provider offering devices from OEM A. In other words, for every 100 devices manufactured by OEM A, 25 devices have errors/defects. These errors or defects may include, but are not limited to, poor network connectivity, inability in charging a device, poor battery performance, overheating, cracked screen, display resolution issues, etc. Regions 1302 and 1304 in FIG. 13 illustrate high error rates associated with particular devices from OEM A. Error rates for devices corresponding to these regions 1302 and 1304 are over 50% and in some cases over 90%. This indicates that the mean accuracy rate is in the range of 10%-50%. Such lower mean accuracy rates may not be acceptable to a wireless network provider. In some implementations, determined mean error rates may be compared to a threshold (or acceptable) mean error rate by the analytics engine 31 to determine whether the error rates are acceptable or not acceptable for a particular OEM. The analytics engine 31 may then instruct the visualization module 612 to provide a notification to quality control personnel. The notification may be provided when the determined mean error rates are higher than the threshold error rate. In some implementations, when the determined mean error rates are less than the threshold error rate, the analytics engine determine that the relationship between return cause codes and corresponding device return rates is “valid” or acceptable. The analytics engine 31 may then instruct the visualization module 612 to provide a notification of validity to quality control personnel.

FIG. 14 illustrates validation results for OEM B. The mean error rate for all OEM B devices is seen to be below 15%. This can indicate that the mean accuracy rate is above 100−15%=85%, which may be acceptable to a wireless network provider offering devices from OEM B. Visualizations of FIGS. 13 and 14 can be generated by the visualization module 612 and are useful because they enable quality control personnel a wireless network provider to identify particular models of devices that have high error rates and then notify the OEM to resolve issues with such devices. Furthermore, by reviewing the validation results, the wireless network provider can determine whether a particular OEM provides a higher quality of devices in comparison to other OEMs.

As noted above, the various implementations disclosed herein relate to forecasting device return rates and causes. The various implementations allow forecasting of a device return rate and identifying the primary root causes of a return. Such forecasting (or prediction) can allow supply chain teams and manufacturing teams to better track the trend of device quality, estimate inventory (e.g., CLNR inventory), estimate backup devices, determine how many pre-launched devices to be ordered, balance CLNR and new devices, and optimize resources. Using one or more algorithms, the disclosed implementations can construct a model to forecast (or trend) device return rate. The disclosed implementations are not limited to mobile devices and can be applied to other domains where return rates may need to be forecasted. For example, the disclosed implementations may be used to forecast return rates for consumer goods, automobiles, food products and other domains that including manufacturing and supply chains. Thus, the implementations provide a generalized model can be applied to resolve issues related to supply chain stocking and returns.

The implementations provide a novel system along with appropriate algorithms and models to quantitatively forecast the device return rate and identify causes (e.g., primary causes) of returns for either a pre-launched or post-launched device. Each device return rate forecasting model is computed to best fit its corresponding device. This increases the accuracy in predicting device return rate for each device. The disclosed implementations select optimal independent variables to regress (or forecast) device return rate. This also helps maintain the high prediction accuracy. In an alternative method, the implementations can traverse all possible cause code combinations to forecast device return rate. Then, a cause code-return rate combination that has a least mean error rate in predicting device return rate is selected as a model to forecast device return rate for a given device type.

The disclosed implementations can further provide a report describing the forecasted return rate including causes for return. The report may include cause codes and KPIs considered in forecasting the device return rate together with an indication of the return rate relative to pre-determined (or acceptable) return rates. For example, the report may include an indication of whether the return rate of the device is above-par, sub-par or on-par relative to pre-determined (or acceptable) return rate levels. The report may be displayed on a user interface of a computing device.

The report may be used to modify aspects related to a supply chain or an inventory of devices. For example, when it is forecasted in the report that the return rate of a device is higher than an acceptable level for a particular return cause code then manufacturer of the device a manufacturer may take actions needed to change certain components of the device during manufacturing or improve quality control for the components associated with the return cause code. In another example, when it is forecasted in that report that devices are to be returned for poor browser performance at a rate higher than an acceptable rate of return, the manufacturer may take actions needed to change the browser of the device during software integration or improve browser testing during software integration. In this way, because the rate of return for a device for a cause code can be forecasted in advance of actual returns and before the device is launched to the market, the manufacturer or a wireless network provider can take pre-emptive actions to address issues with the device. In some implementations, the forecasted return rates for different cause codes may be automatically provided to manufacturing and supply chain components to alter their processes and operations without human intervention. In this scenario, the device return rate forecast report may include or may be replaced by instructions to alter operation of the manufacturing and supply chain components.

A wireless network provider team (or a supply chain team) can leverage the disclosed implementations to identify device return rate trends and primary causes of returns for all pre-launched or post-launched devices from different OEMs. The disclosed implementations provide a neutralized and fair model to identify device return rate trends and primary causes of returns. In general, the disclosed implementations leverage a comprehensive analytical methodology to evaluate device returns and causes of return. A device return rate that is forecasted for a pre-launched device can be used by a wireless network provider to determine how many pre-launched devices to order from OEM and also estimate backup devices to be ordered. The wireless network providers can also balance CLNR stock and new devices to be ordered from OEMs. For example, a higher value of forecasted device return rate can mean more CLNRs. Thus, fewer new devices may need to be ordered from an OEM. Forecasting device return rates helps allocate resources appropriately in terms of human resources, physical resources, and testing equipment resources for testing returned devices.

The device return rate and forecasting service under consideration here may be delivered to touch screen type mobile stations as well as to non-touch type mobile stations. Hence, our simple example shows the mobile station (MS) 13a as a non-touch type mobile station and shows the mobile station (MS) 13 as a touch screen type mobile station. Implementation of the on-line device return rate and forecasting service will involve at least some execution of programming in the mobile stations as well as implementation of user input/output functions and data communications through the network 15, from the mobile stations.

Those skilled in the art presumably are familiar with the structure, programming and operations of the various types of mobile stations. However, for completeness, it may be useful to consider the functional elements/aspects of two exemplary mobile stations 13a and 13b, at a high-level.

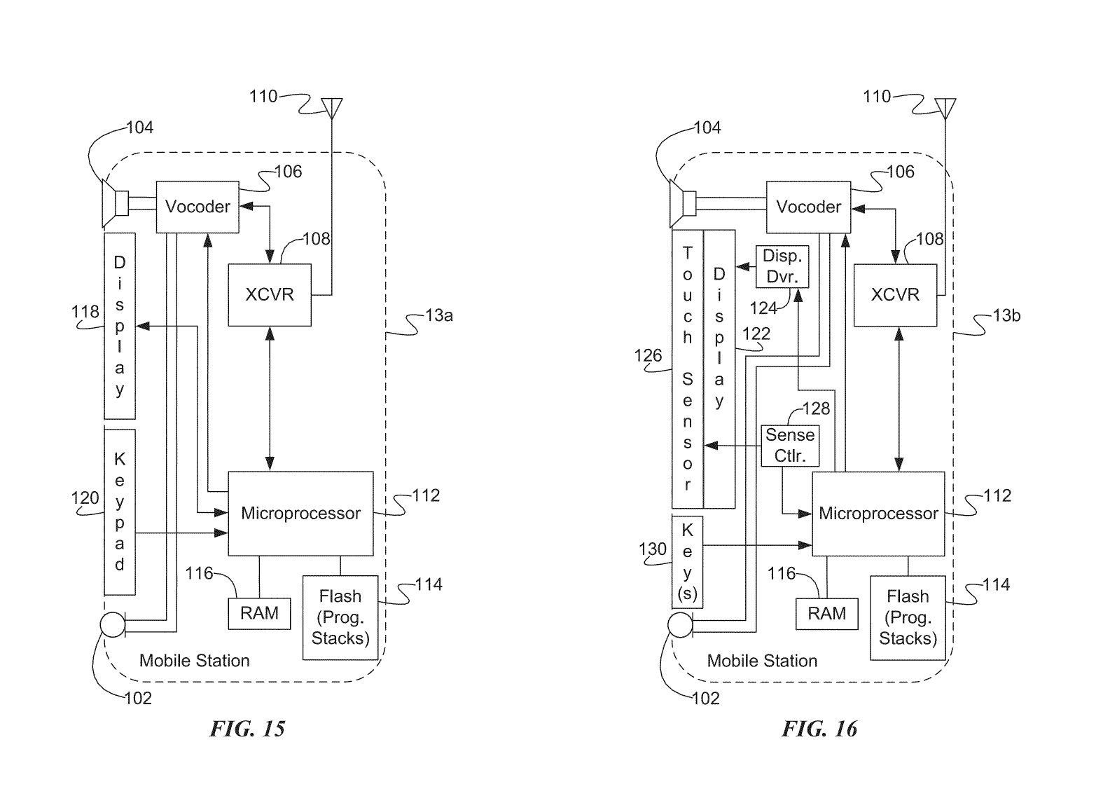

For purposes of such a discussion, FIG. 15 provides a block diagram illustration of an exemplary non-touch type mobile station 13a. Although the mobile station 13a may be a smart-phone or may be incorporated into another device, such as a personal digital assistant (PDA) or the like, for discussion purposes, the illustration shows the mobile station 13a is in the form of a handset. The handset embodiment of the mobile station 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass embodiments of the mobile station 13a utilizing any digital transceivers that conform to current or future developed digital wireless communication standards. The mobile station 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13a and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

The mobile station 13a includes a display 118 for displaying messages, menus or the like, call related information dialed by the user, calling party numbers, etc., including any menus associated with testing of the mobile station 13a by the analytics engine 31. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during testing of the mobile station 13a by the analytics engine 31.

A microprocessor 112 serves as a programmable controller for the mobile station 13a, in that it controls all operations of the mobile station 13a in accord with programming that it executes, for all normal operations. In the example, the mobile station 13a includes flash type program memory 114, for storage of various “software” or “firmware” program routines and mobile configuration settings, such as mobile directory number (MDN) and/or mobile identification number (MIN), etc. The mobile station 13a may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112.

As outlined above, the mobile station 13a includes a processor, and programming stored in the flash memory 114 configures the processor so that the mobile station is capable of performing various desired functions, including in this case the functions involved in the technique for forecasting device return rates.

For purposes of such a discussion, FIG. 16 provides a block diagram illustration of an exemplary touch screen type mobile station 13b. Although possible configured somewhat differently, at least logically, a number of the elements of the exemplary touch screen type mobile station 13b are similar to the elements of mobile station 13a, and are identified by like reference numbers in FIG. 16. For example, the touch screen type mobile station 13b includes a microphone 102, speaker 104 and vocoder 106, for audio input and output functions, much like in the earlier example. The mobile station 13b also includes at least one digital transceiver (XCVR) 108, for digital wireless communications, although the handset 13b may include an additional digital or analog transceiver. The concepts discussed here encompass embodiments of the mobile station 13b utilizing any digital transceivers that conform to current or future developed digital wireless communication standards. As in the station 13a, the transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13b and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

As in the example of station 13a, a microprocessor 112 serves as a programmable controller for the mobile station 13b, in that it controls all operations of the mobile station 13b in accord with programming that it executes, for all normal operations, and for operations involved in forecasting device return rates. In the example, the mobile station 13b includes flash type program memory 114, for storage of various program routines and mobile configuration settings. The mobile station 13b may also include a non-volatile random access memory (RAM) 116 for a working data processing memory. Of course, other storage devices or configurations may be added to or substituted for those in the example. Hence, outlined above, the mobile station 13b includes a processor, and programming stored in the flash memory 114 configures the processor so that the mobile station is capable of performing various desired functions, including in this case the functions involved in the technique for forecasting device return rates.

In the example of FIG. 16, the user interface elements included a display and a keypad. The mobile station 13b may have a limited number of key 130, but the user interface functions of the display and keypad are replaced by a touchscreen display arrangement. At a high level, a touchscreen display is a device that displays information to a user and can detect occurrence and location of a touch on the area of the display. The touch may be an actual touch of the display device with a finger, stylus or other object, although at least some touchscreens can also sense when the object is in close proximity to the screen. Use of a touchscreen display as part of the user interface enables a user to interact directly with the information presented on the display.

Hence, the exemplary mobile station 13b includes a display 122, which the microprocessor 112 controls via a display driver 124, to present visible outputs to the device user. The mobile station 13b also includes a touch/position sensor 126. The sensor 126 is relatively transparent, so that the user may view the information presented on the display 122. A sense circuit 128 sensing signals from elements of the touch/position sensor 126 and detects occurrence and position of each touch of the screen formed by the display 122 and sensor 126. The sense circuit 128 provides touch position information to the microprocessor 112, which can correlate that information to the information currently displayed via the display 122, to determine the nature of user input via the screen.

The display 122 and touch sensor 126 (and possibly one or more keys 130, if included) are the physical elements providing the textual and graphical user interface for the mobile station 13b. The microphone 102 and speaker 104 may be used as additional user interface elements, for audio input and output, including with respect to some device return rate forecasting related functions.

The structure and operation of the mobile stations 13a and 13b, as outlined above, were described to by way of example, only.

As shown by the above discussion, functions relating to forecasting device return rates, via a graphical user interface of a mobile station may be implemented on computers connected for data communication via the components of a packet data network, operating as the analytics engine 31 as shown in FIG. 1. Although special purpose devices may be used, such devices also may be implemented using one or more hardware platforms intended to represent a general class of data processing device commonly used to run “server” programming so as to implement functions for forecasting device return rate discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for device return rate forecasting. The software code is executable by the general-purpose computer that functions as the analytics engine. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for device return rate forecasting, in essentially the manner performed in the implementations discussed and illustrated herein.

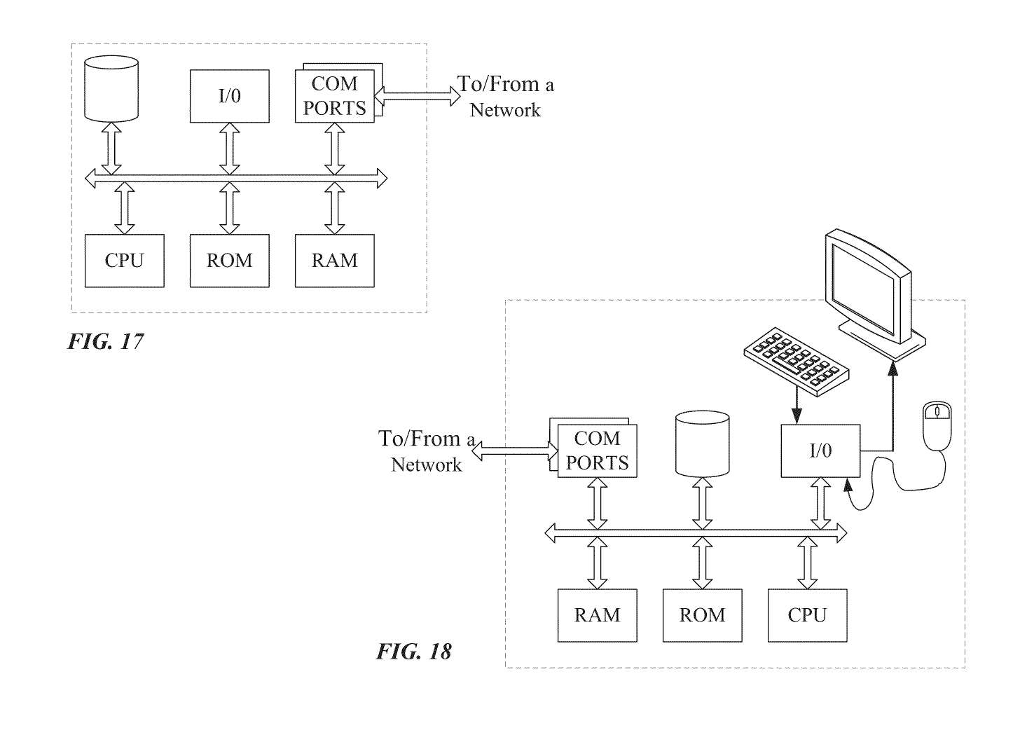

FIGS. 17 and 18 provide functional block diagram illustrations of general purpose computer hardware platforms. FIG. 17 illustrates a network or host computer platform, as may typically be used to implement a server. FIG. 18 depicts a computer with user interface elements, as may be used to implement a personal computer or other type of work station or terminal device, although the computer of FIG. 18 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 17). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of device return rate forecasting outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of a wireless network provider into the computer platform of the analytics engine. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the device return rate forecasting, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
identifying correlations between device return cause codes and corresponding device return rates for one or more devices, wherein a device return cause code represents a reason for return of a device to a vendor of the device and wherein a corresponding device return rate is indicative of a number of times the device is returned with the device return cause code;
computing, based on the identified correlations, correlation indexes for each of the device return cause codes;
ranking the computed correlation indexes associated with each of the device return cause codes;
selecting, based on the ranking, a subset of device return cause codes, the subset including device return cause codes having higher computed correlation indexes relative to other device return cause codes;
determining a relationship between the selected subset of the return cause codes and corresponding device return rates using the subset of the device return cause codes as independent variables for the determining of the relationship;
mapping one or more measured key performance indicators (KPIs) of a particular device to return cause codes of the device, wherein KPIs belonging to particular performance category are mapped to each corresponding cause code of the performance category; and
estimating a device return rate for the particular device based on the mapped KPIs and the determined relationship;
based on the estimated device return rate, providing one or more instructions to supply chain components to adjust supply chain operations.

2. The method of claim 1, wherein the device is a pre-launched mobile device having no known device return cause codes.

3. The method of claim 1, wherein the relationship is determined using a regression algorithm.

4. The method of claim 1, wherein the identified correlations are based on an identified regressional relation between the device return cause codes and corresponding return rates.

5. The method of claim 1, further comprising:
computing a difference between the estimated device return rate and a true device return rate for the particular device;
computing respective differences between estimated device return rates and true device return rates for other devices of the one or more devices; and
determining a mean error rate for the determined relationship based the computed difference and the computed respective differences.

6. The method of claim 1, further comprising:
comparing the determined mean error rate to a threshold value; and
when the determined mean error rate is less than the threshold value, determining that the determined relationship is valid.

7. The method of claim 1, wherein the selected subset of device return cause codes jointly regress corresponding device return rates in a multi-dimensional space.

8. The method of claim 1, wherein the device return cause codes and the device return rates are represented as time-based series.

9. An analytics engine comprising:
a communication interface configured to enable communication via a mobile network;
a processor coupled with the communication interface;
a storage device accessible to the processor; and
an executable program in the storage device, wherein execution of the program by the processor configures the server to perform functions, including functions to:
identify correlations between device return cause codes and corresponding device return rates for one or more devices, wherein a device return cause code represents a reason for return of a device to a vendor of the device and wherein a corresponding device return rate is indicative of a number of times the device is returned with the device return cause code;
compute, based on the identified correlations, correlation indexes for each of the device return cause codes;
rank the computed correlation indexes associated with each of the device return cause codes;
select, based on the ranking, a subset of device return cause codes, the subset including device return cause codes having higher computed correlation indexes relative to other device return cause codes;
determine a relationship between the selected subset of the return cause codes and corresponding device return rates using the subset of the device return cause codes as independent variables for the determining of the relationship;
map one or more measured key performance indicators (KPIs) of a particular device to return cause codes of the device, wherein KPIs belonging to particular performance category are mapped to each corresponding cause code of the performance category;
estimate a device return rate for the particular device based on the mapped KPIs and the determined relationship; and
based on the estimated device return rate, provide one or more instructions to supply chain components to adjust supply chain operations.

10. The analytics engine of claim 9, wherein the device is a pre-launched mobile device having no known device return cause codes.

11. The analytics engine of claim 9, wherein the relationship is determined using a regression algorithm.

12. The analytics engine of claim 9, wherein execution of the program by the processor configures the server to perform functions, including functions to:
generate a visualization of a relationship between a particular device return cause code and corresponding device return rate.

13. The analytics engine of claim 9, wherein execution of the program by the processor configures the server to perform functions, including functions to:
compute a difference between the estimated device return rate and a true device return rate for the particular device;
compute respective differences between estimated device return rates and true device return rates for other devices of the one or more devices; and
determine a mean error rate for the determined relationship based the computed difference and the computed respective differences.

14. The analytics engine of claim 9, wherein execution of the program by the processor configures the server to perform functions, including functions to:
compare the determined mean error rate to a threshold value; and
when the determined mean error rate is less than the threshold value, determine that the determined relationship is valid.

15. The analytics engine of claim 9, wherein the selected subset of device return cause codes jointly regress corresponding device return rates in a multi-dimensional space.

16. The analytics engine of claim 9, wherein the device return cause codes and the device return rates are represented as time-based series.

17. A non-transitory computer-readable medium comprising instructions which, when executed by one or more computers, cause the one or more computers to:
identify correlations between device return cause codes and corresponding device return rates for one or more devices, wherein a device return cause code represents a reason for return of a device to a vendor of the device and wherein a corresponding device return rate is indicative of a number of times the device is returned with the device return cause code;
compute, based on the identified correlations, correlation indexes for each of the device return cause codes;
rank the computed correlation indexes associated with each of the device return cause codes;
select, based on the ranking, a subset of device return cause codes, the subset including device return cause codes having higher computed correlation indexes relative to other device return cause codes;
determine a relationship between the selected subset of the return cause codes and corresponding device return rates using the subset of the device return cause codes as independent variables for the determining of the relationship;
map one or more measured key performance indicators (KPIs) of a particular device to return cause codes of the device, wherein KPIs belonging to particular performance category are mapped to each corresponding cause code of the performance category;
estimate a device return rate for the particular device based on the mapped KPIs and the determined relationship; and
based on the estimated device return rate, provide one or more instructions to supply chain components to adjust supply chain operations.

18. The computer-readable medium of claim 17, wherein the device is a pre-launched mobile device having no known device return cause codes.

19. The computer-readable medium of claim 17, wherein the relationship is determined using a regression algorithm.

20. The computer-readable medium of claim 17 further comprising instructions which, when executed by the one or more computers, cause the one or more computers to:
generate a visualization of a relationship between a particular device return cause code and corresponding device return rate.
